(19) United States
(12) Patent Application Publication
(10) Pub. No.: US 2021/0331359 A1
(43) Pub. Date: Oct. 28, 2021

(54) AUTOMOTIVE TRIM DEVICE

(71) Applicant: Proprietect L.P., Toronto, ON (CA)

(72) Inventors: Joseph F. LANDIS, Macomb, MI (US); Amir ZOLFAGHARI, Beverly Hills, MI (US)

(21) Appl. No.: 17/260,671

(22) PCT Filed: Jul. 23, 2019
(86) PCT No.: PCT/CA2019/051011

§ 371 Date: Jan. 15, 2021

Related U.S. Application Data
(60) Provisional application No. 62/764,168, filed on Jul. 23, 2018.

(51) Int. Cl. B29C 44/12; B60R 13/02; B60N 2/80; B29C 44/14

(52) U.S. Cl. CPC B29C 44/1271; B60R 13/02; B29L 2031/3023; B29C 44/146; B60N 2/80

(57) ABSTRACT

The present invention relates to an automotive trim device and a process for making the same. The automotive trim device comprises a foam body with a cavity, into which a mechanism comprising both functionality-conferring elements and a frame element can be inserted. The foam body is manufactured from liquid foam and uses tooling for the inner core. After the foam body has formed, the tooling is removed and the mechanism can be inserted into the foam body, thereby preventing the mechanism from being exposed to liquid foam. An advantage of the present invention is that the automotive trim device can be used with electrical and/or mechanical devices containing components sensitive to the intrusion and curing of liquid foamable materials. The process may also provide mass and cost savings due to reductions in scrap and material, as compared to other known methods of manufacture.

### CROSS-REFERENCE TO RELATED APPLICATION

The present application claims the benefit under 35 U.S.C. § 119(e) of provisional patent application Ser. No. 62/764,168, filed Jul. 23, 2018, the contents of which are hereby incorporated by reference.

### BACKGROUND OF THE INVENTION

### Field of the Invention

In one of its aspects, the present invention relates an automotive trim device, and more particularly an automotive trim device comprising a functionality-conferring element and a frame element. In another of its aspects, the present invention relates to a process for manufacturing an automotive trim device, and more particularly a process for manufacturing an automotive trim device comprising a functionality-conferring element and a frame element. The automotive trim device may be used, for example, in such applications as an automobile head restraint, armrest, storage bin cover, instrument panel, stationary seat bolster and the like.

### Description of the Prior Art

Automotive trim devices, such as head restraints or armrests, are typically fabricated from a foam material (usually a polyurethane foam) and covered with a trim cover. Automotive trim devices can also contain one or more mechanisms, which can vary depending on the purpose of the trim device. Such mechanisms can include frame elements to secure the device to the interior of the automobile or mechanical and/or electrical elements which can add functionality to the trim device.

Conventionally, such an automotive trim device has been produced using a so-called “foam in place” or “pour in place” process. In this process, the mechanical element and the trim cover are placed in a mold comprising a first mold element and a second mold element reversibly engageable to define a mold cavity. Thus, it is conventional to line the bowl with the trim cover with the finished surface of the trim cover against the surface of the bowl of the mold. The mechanical element is mechanically secured in a prescribed position with respect to the bowl and the lid of the mold. A liquid foamable material is then introduced into the bowl of the mold, filling the space around the mechanism.

This approach can provide improved craftmanship, enhanced design flexibility, an overall cleaner look and improved manufacturing efficiency. However, with the foam in place process, the mechanism often must be enclosed in a protective housing to shield it from the liquid foam. This is particularly true when the mechanism comprises electrical and/or mechanical elements that may be sensitive to the intrusion and curing of foam materials. The addition of a protective housing can both increase material costs and the overall mass of the trim device. Furthermore, the risk of the liquid foam penetrating the protective housing and binding the mechanism may not be fully eliminated by the housing.

Despite the advances made to date in the manufacture of automotive trim devices, there is room for improvement to address the above-mentioned problems and shortcomings of the prior art.

### SUMMARY OF THE INVENTION

It is an object of the present invention to obviate or mitigate at least one of the above-mentioned disadvantages of the prior art.

It is another object of the present invention to provide a novel automotive interior trim device.

It is another object of the present invention to provide a novel process for manufacturing an automotive interior trim device.

Accordingly, in one of its aspects, the present invention provides an automotive trim device comprising: (a) a foam body portion, the body portion defining a cavity therein; (b) a functionality-conferring element; and (c) a frame element; wherein the functionality-conferring element and the frame element are disposed in the cavity of the foam body portion after the foam body portion is formed (the foam body portion is not molded in place with respect to the functionality-conferring element).

In another of its aspects, the present invention provides a process for manufacturing an automotive trim device, the process comprising the following steps:

(a) placing a trim cover and a tooling mandrel into a mold, the trim cover surrounding at least a portion of the tooling mandrel and to define a molding cavity therebetween;

(b) dispensing a liquid foamable polymeric composition into the molding cavity;

(c) expanding the liquid foamable polymeric composition to produce a foam body element in the molding cavity,

(d) removing the tooling mandrel to define a receptacle in the foam body element; and

(e) inserting a functionality-conferring element and a frame element into the receptacle in the foam body element.

In yet another of its aspects, the present invention provides a process for manufacturing an automotive trim device, the process comprising the following steps:

(a) placing a trim cover and a tooling mandrel into a mold, the trim cover and the mold each having an inner surface and an outer surface, the inner surface of the trim cover surrounding at least a portion of the tooling mandrel and the outer surface of the trim cover being in contact with at least a portion of the inner surface of the mold;

(b) dispensing a liquid foamable polymeric composition into a spaced defined by the inner surface of the trim cover and the tooling mandrel;

(c) expanding the liquid foamable polymeric composition to produce a foam body element in the space,

(d) removing the tooling mandrel to define a cavity in the foam body element; and

(e) inserting a functionality-conferring element and a frame element into the cavity in the foam body element.

As used throughout this specification, the term “automotive trim device” is intended to mean a device comprising a foam element and functionality-conferring element coupled secured with respect to one another in combination with a trim cover element that covers the foam element and at least a portion of the functionality-conferring element. The term “automotive trim device” excludes automotive seat elements such as a seat bottom and a seat back. Examples of an “automotive trim device” include an automobile head restraint, an armrest, a storage bin cover, an instrument panel, a stationary seat bolster and the like.

The term “functionality-conferring element”, as used throughout this specification, is intended to mean an element which confers mechanical and/or electrical functionality to automotive trim device. The term “mechanical” is intended to be broad and include elements that confer movement and stationary elements such as housings, foam inserts and the like.

For example, in the case of an automotive head restraint, the functionality-conferring element could confer adjustment (e.g., one or both of tilting and up/down movement)—in this case, the element could be mechanical, electrical or a combination of both. The point is the functionality-conferring element in the automotive head restraint embodiment is secured with respect to the foam element and at least a portion of the functionality-conferring element is covered by the trim cover element. Alternatively, or in addition, the functionality-conferring element could be a housing for a speaker for provision of acoustic functionality from the automotive head restraint.

Thus, the present inventors have developed an automotive trim device comprising a foam body with a cavity into which a functionality-conferring element and a frame element can be inserted. This automotive trim device can be used with electrical and/or mechanical devices containing components sensitive to the intrusion and curing of liquid foamable materials. The present inventors have also developed process for manufacturing the present automotive trim device that may reduce manufacturing costs due to reductions in scrap and material as well as reduce the overall mass of the automotive trim device, as compared to other known methods of manufacture. To the knowledge of the inventors, an automotive trim device having such a combination of features and a process for manufacturing the same is heretofore unknown.

Other advantages of the invention will become apparent to those of skill in the art upon reviewing the present specification.

### BRIEF DESCRIPTION OF THE DRAWINGS

Embodiments of the present invention will be described with reference to the accompanying drawings, wherein like reference numerals denote like parts, and in which:

FIG. 1(a) illustrates a 3D side view of a schematic diagram of a preferred embodiment of the present automotive trim device.

FIG. 1(b) illustrates a 2D side view of a schematic diagram of the preferred embodiment of the present automotive trim device illustrated in FIG. 1(a).

FIG. 2(a) illustrates a 3D front view of a schematic diagram of a mechanism housing for the preferred embodiment of the present automotive trim device illustrated in FIG. 1.

FIG. 2(b) illustrates a 3D rear view of a schematic diagram of a mechanism housing for the preferred embodiment of the present automotive trim device illustrated in FIG. 2(a), wherein the mechanism housing has a back cover.

FIG. 2(c) illustrates a 3D rear view of a schematic diagram of one piece design for a mechanism housing for the preferred embodiment of the present automotive trim device illustrated in FIG. 2(a), wherein the mechanism housing does not have a back cover.

FIG. 3 illustrates a schematic diagram of the foam in place process, as generally known in the prior art.

FIG. 4 illustrates a schematic diagram of a preferred embodiment of the process for manufacturing the present automotive trim device.

FIG. 5 illustrates an enlarged schematic view of steps in a preferred embodiment of the process for manufacturing the present automotive trim device.

### DETAILED DESCRIPTION OF THE PREFERRED EMBODIMENTS

The present invention relates to an automotive trim device comprising: (a) a foam body portion, the body portion defining a cavity therein; (b) a functionality-conferring element; and (c) a frame element; wherein the functionality-conferring element and the frame element are disposed in the cavity of the foam body portion after the foam body portion is formed (the foam body portion is not molded in place with respect to the functionality-conferring element).

Preferred embodiments of this automotive trim device may include any one of or a combination of any two or more of any of the following features:
the automotive trim device further comprises a trim cover element;
the trim cover element at least partially encapsulates the body portion;
the trim cover comprises at least one of vinyl, cloth or leather;
the body portion comprises a polymeric material;
the polymeric material is polyurethane foam;
the functionality-conferring element comprises at least one electrical device;
the functionality-conferring element comprises at least one mechanical device;
the functionality-conferring element comprises at least one of an electrical device or a mechanical device, the at least one electrical or mechanical device containing at least one component that is sensitive to the intrusion and curing of foam materials;
the functionality-conferring element is at least partially enclosed in a housing;
the functionality-conferring element is free of a housing;
the frame element is configured to secure the automotive trim device to a portion of the automobile;
the frame element and functionality-conferring element are integral;
the frame element and functionality-conferring element are integral with the housing;
the frame element and functionality-conferring element are separate
the frame element, functionality-conferring element, and housing are separate;
the frame element or functionality-conferring element are integral with the housing;
the cavity has a shape and size substantially complementary to the shape and size of the functionality-conferring element and portion of the frame element that are disposed in the cavity;
the trim device is a head restraint, an armrest, a storage bin, an instrument panel, or a stationary seat bolster;
the device is automotive head restraint;
the functionality-conferring element confers one or more of the following functions to the automotive head restraint: horizontally adjustability, vertically adjustability, stowability, foldability, acoustic, video display, counter-balancing, vibration dampening and containment for any of these;
the device is an armrest;
the functionality-conferring element confers one or more of the following functions to the armrest: latchability, lockability, stowability, foldability, electrical controls, one or more heating devices and containment for any of these;
the automotive trim device is a storage bin;
the functionality-conferring element confers one or more of the following functions to the storage bin: latchability, lockability, stowability, foldability, electrical controls, one or more heating devices and containment for any of these;
the automotive trim device is an instrument panel;
the functionality-conferring element confers one or more of the following functions to the instrument panel: latchability, lockability, stowability, foldability, acoustic, video, electrical controls, one or more heating devices and containment for any of these;
the automotive trim device is a stationary seat bolster; and/or
the functionality-conferring element confers containment for one or more airbags to the stationary seat bolster.

The present invention also relates to a process for manufacturing an automotive trim device, the process comprising the following steps: (a) placing a trim cover and a tooling mandrel into a mold, the trim cover surrounding at least a portion of the tooling mandrel and to define a molding cavity therebetween; (b) dispensing a liquid foamable polymeric composition into the molding cavity; (c) expanding the liquid foamable polymeric composition to produce a foam body element in the molding cavity, (d) removing the tooling mandrel to define a receptacle in the foam body element; and (e) inserting a functionality-conferring element and a frame element into the receptacle in the foam body element.

The present invention also relates to a process for manufacturing an automotive trim device, the process comprising the following steps: (a) placing a trim cover and a tooling mandrel into a mold, the trim cover and the mold each having an inner surface and an outer surface, the inner surface of the trim cover surrounding at least a portion of the tooling mandrel and the outer surface of the trim cover being in contact with at least a portion of the inner surface of the mold; (b) dispensing a liquid foamable polymeric composition into a spaced defined by the inner surface of the trim cover and the tooling mandrel; (c) expanding the liquid foamable polymeric composition to produce a foam body element in the space, (d) removing the tooling mandrel to define a cavity in the foam body element; and (e) inserting a functionality-conferring element and a frame element into the cavity in the foam body element

Preferred embodiments of this method may include any one of or a combination of any two or more of any of the following features:
the tooling mandrel has an upper and a lower portion, the lower portion being interior to the mold cavity and the upper portion being exterior to the receptacle in the foam body element;
the lower portion of the tooling mandrel has a shape and size substantially complementary to the shape and size of the functionality-conferring element and portion of the frame element that are disposed in the cavity in the foam body element;
the lower portion of the tooling mandrel has a shape and size substantially complementary to the shape and size of the functionality-conferring element and portion of the frame element that are disposed in the cavity;
the process further comprises closing out the trim cover;
the mold further comprises a first mold portion and a second mold portion releasably engageable between an open position and a closed position defining a mold cavity;
the mold cavity is in the open or closed position when the liquid foamable polymeric material is introduced;
the tooling mandrel is constructed of a material selected from wood, polymer material, metal, fiberglass or a composite thereof;
the automotive trim device further comprises a trim cover element;
the trim cover element at least partially encapsulates the body portion;
the trim cover comprises at least one of vinyl, cloth or leather;
the body portion comprises a polymeric material;
the polymeric material is polyurethane foam;
the functionality-conferring element comprises at least one electrical device;
the functionality-conferring element comprises at least one mechanical device;
the functionality-conferring element comprises at least one of an electrical device or a mechanical device, the at least one electrical or mechanical device containing at least one component that is sensitive to the intrusion and curing of foam materials;
the functionality-conferring element is at least partially enclosed in a housing;
the functionality-conferring element is free of a housing;
the frame element is configured to secure the automotive trim device to a portion of the automobile;
the frame element and functionality-conferring element are integral;
the frame element and functionality-conferring element are integral with the housing;
the frame element and functionality-conferring element are separate
the frame element, functionality-conferring element, and housing are separate;
the frame element or functionality-conferring element are integral with the housing;
the cavity has a shape and size substantially complementary to the shape and size of the functionality-conferring element and portion of the frame element that are disposed in the cavity;
the trim device is a head restraint, an armrest, a storage bin, an instrument panel, or a stationary seat bolster;
the device is automotive head restraint;
the functionality-conferring element confers one or more of the following functions to the automotive head restraint: horizontally adjustability, vertically adjustability, stowability, foldability, acoustic, video display, counter-balancing, vibration dampening and containment for any of these;
the device is an armrest;
the functionality-conferring element confers one or more of the following functions to the armrest: latchability, lockability, stowability, foldability, electrical controls, one or more heating devices and containment for any of these;
the automotive trim device is a storage bin;
the functionality-conferring element confers one or more of the following functions to the storage bin: latchability, lockability, stowability, foldability, electrical controls, one or more heating devices and containment for any of these;
the automotive trim device is an instrument panel;
the functionality-conferring element confers one or more of the following functions to the instrument panel: latchability, lockability, stowability, foldability, acoustic, video, electrical controls, one or more heating devices and containment for any of these;
the automotive trim device is a stationary seat bolster; and/or
the functionality-conferring element confers containment for one or more airbags to the stationary seat bolster.

Preferred embodiments of the present invention will be described with reference to the following exemplary information which should not be used to limit or construe the invention. In the discussion of the preferred embodiments, reference will be made to an automotive head restraint. However, it should be clearly understood that this is for illustrative purposes on and that the present invention more broadly relates to am automotive trim device as described above.

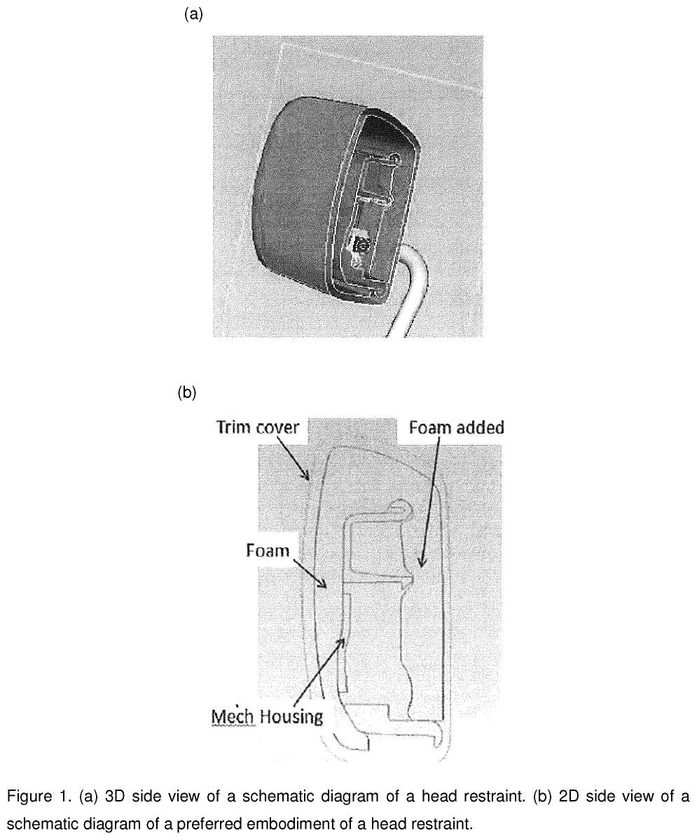

FIG. 1 illustrates a schematic of a preferred embodiment of the present automotive trim device. With reference to FIG. 1, there is illustrated an automotive head restraint. The head restraint comprises a trim cover and a foam body. A mechanism is disposed within the foam body. The foam body surrounds the mechanism on the front, top, and back of the head restraint. In the embodiment illustrated in FIG. 1, the mechanism is enclosed in a housing. However, as will be discussed further below, it will be understood that in other embodiments, the mechanism may be partially enclosed within a housing or may not include a housing.

The trim cover may be made of any suitable material known in the art, including leather, cloth, vinyl, and the like. The foam body may be made of a liquid foamable polymeric composition or any other suitable material known in the art. In a preferred embodiment, the foam body comprises polyurethane foam.

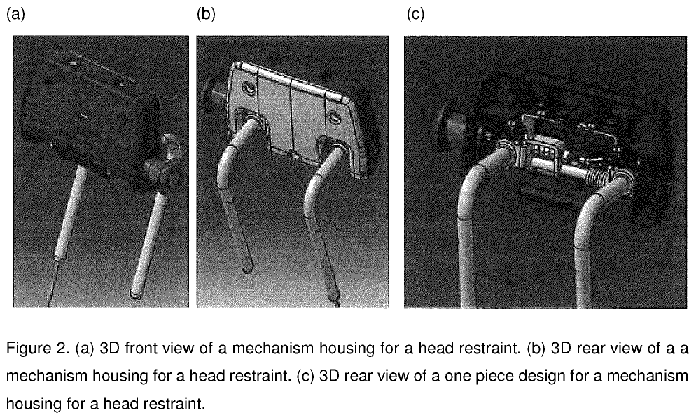

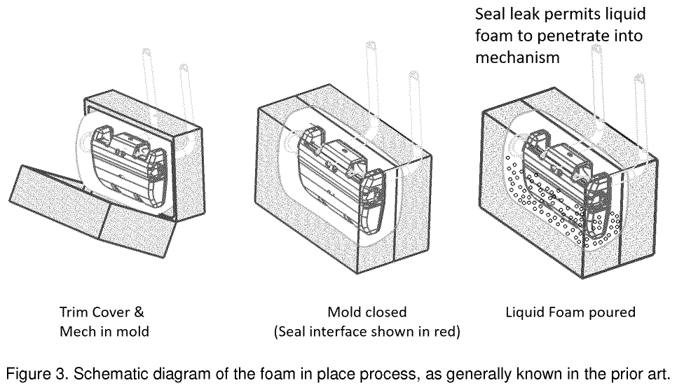

As illustrated in FIG. 2, the mechanism may be fully or partially enclosed in a housing. The mechanism may have a front panel, as illustrated in FIG. 2(a). It may also have a back panel, as illustrated in FIG. 2(b), or it may not have a back panel, as illustrated in FIG. 2(c). As further illustrated in FIG. 2(c), the mechanism and housing may be constructed in a one piece design or may comprise separate elements. Alternatively, the mechanism may not have a housing.

Generally, the functionality-conferring element may be considered to be a mechanism. The mechanism may include any known or later developed electrical or mechanical device. The mechanism may include more than one such electrical and/or mechanical device. Such devices may include electrical or mechanical devices that enable the automotive trim device to be one or more of horizontally adjustable, vertically adjustable, stowable/foldable, or latchable/lockable; or to contain one or more of speakers, video displays, counter-balances, vibration dampers, electrical controls, heaters, latching mechanisms, locking mechanisms, or airbags. Such electrical or mechanical devices may contain components sensitive to the intrusion or curing of foam materials.

The mechanism may also include a frame element for securing the automotive trim device to the interior of the automobile. The frame element may be constructed from a rigid material, such as metal or any other suitable material, and may be any suitable configuration to secure the device to an interior structure. In the embodiment illustrated in FIG. 2, the frame element comprises two posts for coupling to the seat back of an automobile. The posts are interconnected by a cross-piece and bent at a 90° angle, as illustrated in FIG. 2(c). The precise design of the frame element is within the purview of a person skilled in the art.

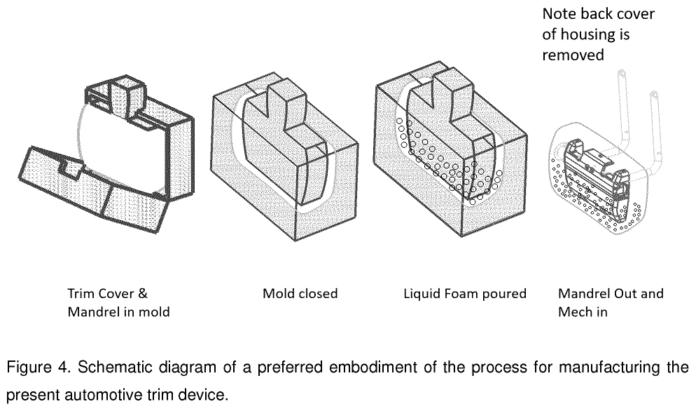

With reference to FIG. 4, there is illustrated a process for manufacturing the present automotive trim device. With the present invention, a trim cover with a 3D molded foam body is produced without the mechanism in place. Instead, a tooling mandrel is used to create a cavity in the foam body. The mechanism can then be inserted into the foam body cavity once the foam has set, thereby preventing liquid foam from binding the mechanism.

As illustrated in FIG. 4, the trim cover is placed onto a tooling mandrel. The tooling mandrel and trim cover are then placed into a mold and the mold is closed. A liquid foamable composition, preferably liquid polyurethane foam, is poured into the space between the interior surface of the trim cover and tooling mandrel to form a foam body, which adheres to the inner surface of the trim cover. The trim cover-foam body combination is then removed from the mold and the tooling mandrel is removed, leaving a cavity in the foam body. A mechanism, as described above, is then inserted into the cavity in the foam body. The trim cover can then be closed out. This can be done by conventional including stitching the edges of the trim cover into a seam, a touch-fastener (e.g., Velcro™) system and the like.

The tooling mandrel can be configured such that the cavity formed by the tooling mandrel is of the appropriate size and shape of the mechanism to be inserted into it. Preferably, the size and shape of the tooling mandrel is substantially complementary with respect to the combination of the mechanism and the portion of the frame element being inserted into the foam body. In other words, it is preferred that the receptacle formed by the tooling mandrel has substantially the same size and shape of the combination of the mechanism and the portion of the frame element being inserted therein.

The tooling mandrel can be produced from any suitable material such as metal, wood plastic and the like. Also, the tooling mandrel can be in the form a single piece or a combination of pieces secured to one another.

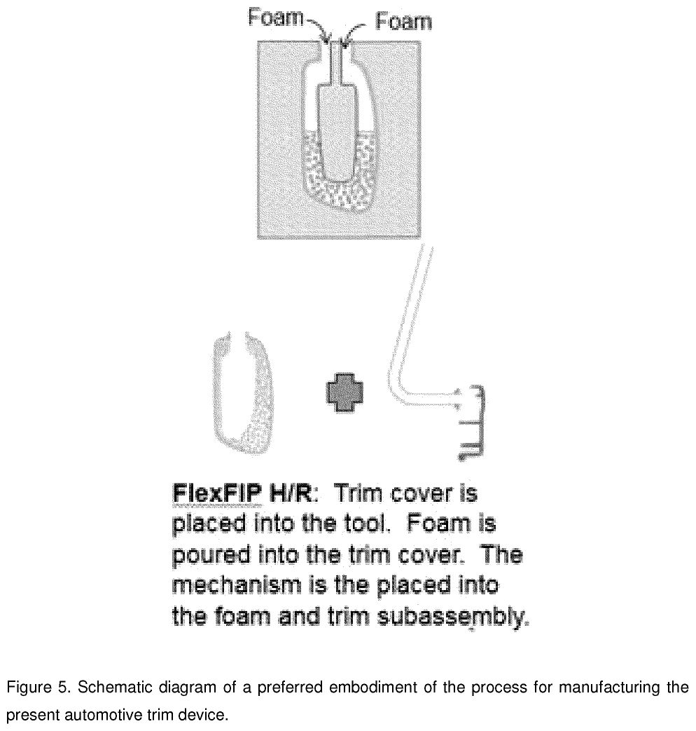

FIG. 5 shows an enlarged schematic view of the foaming step (top) and mechanism insertion (bottom) step of the present process.

Other embodiments of the present invention may include other interior automotive applications such as an armrest, a storage bin, an instrument panel, and a stationary seat bolster.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent, or patent application was specifically and individually indicated to be incorporated by reference in its entirety.

1. An automotive trim device comprising:
(a) a body portion, the body portion defining a cavity therein;
(b) a functionality-conferring element; and
(c) a frame element;
wherein the functionality-conferring element and at least a portion the frame element are disposed in the cavity of the body portion after the body portion is formed.

2. The automotive trim device defined in claim 1, wherein the automotive trim device further comprises a trim cover element.

3. The automotive trim device defined in claim 2, wherein the trim cover element at least partially encapsulates the body portion.

4. (canceled)

5. The automotive trim device defined in claim 1, wherein the body portion comprises a polymeric material.

6. (canceled)

7. (canceled)

8. (canceled)

9. The automotive trim device defined in claim 1, wherein the functionality-conferring element comprises at least one of an electrical device or a mechanical device, the at least one electrical or mechanical device containing at least one component that is sensitive to the intrusion and curing of foam materials.

10. The automotive trim device defined in claim 1, wherein the functionality-conferring element is at least partially enclosed in a housing.

11. (canceled)

12. The automotive trim device defined in claim 1, wherein the frame element is configured to secure the automotive trim device to a portion of an automobile.

13. The automotive trim device defined in claim 1, wherein the frame element and functionality-conferring element are integral.

14. The automotive trim device defined in claim 10, wherein the frame element and functionality-conferring element are integral with the housing.

15. The automotive trim device defined in claim 1, wherein the frame element and functionality-conferring element are separate.

16. The automotive trim device defined in claim 10, wherein the frame element, functionality-conferring element, and housing are separate.

17. The automotive trim device defined in claim 15, wherein one of the frame element or functionality-conferring element are integral with the housing.

18. The automotive trim device defined in claim 1, wherein the cavity has a shape and size substantially complementary to the shape and size of the functionality-conferring element and portion of the frame element that are disposed in the cavity.

19. (canceled)

20. The automotive trim device defined in claim 19, wherein the automotive trim device is automotive head restraint.

21. The automotive trim device defined in claim 20, wherein the functionality-conferring element confers one or more of the following functions to the automotive head restraint: horizontally adjustability, vertically adjustability, stowability, foldability, acoustic, video display, counter-balancing, vibration dampening and containment for any of these.

22. The automotive trim device defined in claim 19, wherein the automotive trim device is an armrest.

23. The automotive trim device defined in claim 22, wherein the functionality-conferring element confers one or more of the following functions to the armrest: latchability, lockability, stowability, foldability, electrical controls, one or more heating devices and containment for any of these.

24. The automotive trim device defined in claim 19, wherein the automotive trim device is a storage bin.

25. The automotive trim device defined in claim 24, wherein the functionality-conferring element confers one or more of the following functions to the storage bin: latchability, lockability, stowability, foldability, electrical controls, one or more heating devices and containment for any of these.

26. The automotive trim device defined in claim 19, wherein the automotive trim device is an instrument panel.

27. The automotive trim device defined in claim 26, wherein the functionality-conferring element confers one or more of the following functions to the instrument panel: latchability, lockability, stowability, foldability, acoustic, video, electrical controls, one or more heating devices and containment for any of these.

28. The automotive trim device defined in claim 19, wherein the automotive trim device is a stationary seat bolster.

29. The automotive trim device defined in claim 28, wherein the functionality-conferring element confers containment for one or more airbags to the stationary seat bolster.

30. A process for manufacturing an automotive trim device, the process comprising the following steps:
(a) placing a trim cover and a tooling mandrel into a mold, the trim cover surrounding at least a portion of the tooling mandrel and to define a molding cavity therebetween;
(b) dispensing a liquid foamable polymeric composition into the molding cavity;
(c) expanding the liquid foamable polymeric composition to produce a foam body element in the molding cavity,
(d) removing the tooling mandrel to define a receptacle in the foam body element; and
(e) inserting a functionality-conferring element and at least portion a frame element into the receptacle in the foam body element.

31. A process for manufacturing an automotive trim device, the process comprising the following steps:
(a) placing a trim cover and a tooling mandrel into a mold, the trim cover and the mold each having an inner surface and an outer surface, the inner surface of the trim cover surrounding at least a portion of the tooling mandrel and the outer surface of the trim cover being in contact with at least a portion of the inner surface of the mold;
(b) dispensing a liquid foamable polymeric composition into a spaced defined by the inner surface of the trim cover and the tooling mandrel;
(c) expanding the liquid foamable polymeric composition to produce a foam body element in the space,
(d) removing the tooling mandrel to define a cavity in the foam body element; and
(e) inserting a functionality-conferring element and at least a portion of a frame element into the cavity in the foam body element.

32-64. (canceled)
